(19) United States
(12) Patent Application Publication
(10) Pub. No.: US 2012/0227003 A1
(43) Pub. Date: Sep. 6, 2012

(54) ELECTRONIC DEVICE WITH FUNCTION OF DISTINGUISHING WORKING STATE OF OPTION MENUS AND METHOD THEREOF

(75) Inventor: WEI-LIANG CHEN, Tu-Cheng (TW)

(73) Assignee: HON HAI PRECISION INDUSTRY CO., LTD., Tu-Cheng (TW)

(21) Appl. No.: 13/095,864

(22) Filed: Apr. 28, 2011

(30) Foreign Application Priority Data
Mar. 3, 2011 (CN) 201110051156.9

(51) Int. Cl. G06F 3/048

(52) U.S. Cl. 715/765

(57) ABSTRACT

An electronic device with a function of distinguishing working state of option menus includes an input unit, a display unit, and a processing unit. The processing unit includes a display control module. The display control module displays a function setting interface. The function setting interface includes a first display area for displaying the option menus whose functions are activated and a second display area for displaying the option menus whose functions are not activated. A method with a function of distinguishing working state of option menus is also provided.

### BACKGROUND

1. Technical Field

The present disclosure relates to electronic devices and, particularly, to an electronic device with a function of quickly distinguishing the working state of option menus and a method thereof.

2. Description of Related Art

Many electronic devices display a number of option menus on a display for users to activate, thereby helping the users to use the electronic devices. The option menus are often kept in an original position even if the option menu is activated, which can confuse the users as to which option menus are enabled and which option menus are disabled.

Therefore, what is needed is an electronic device with a function of quickly distinguishing working state of option menus to overcome the described limitations.

### BRIEF DESCRIPTION OF THE DRAWINGS

FIG. 1 is a block diagram of a hardware infrastructure of an electronic device with a function of distinguishing working state of option menus, in accordance with an exemplary embodiment.

FIG. 2 shows a function setting interface of the electronic device of FIG. 1.

FIG. 3 shows an option menu being moved from a second display area to a first display area.

FIG. 4 is a block diagram of a hardware infrastructure of an electronic device with function of distinguishing working state of option menus, in accordance with a second embodiment.

FIG. 5 is a block diagram of a hardware infrastructure of an electronic device with function of distinguishing working state of option menus, in accordance with a third embodiment.

FIG. 6 is a flowchart of a method for distinguishing working state of option menus implemented by the electronic device of FIG. 1, 4, or 5, in accordance with exemplary embodiment.

### DETAILED DESCRIPTION

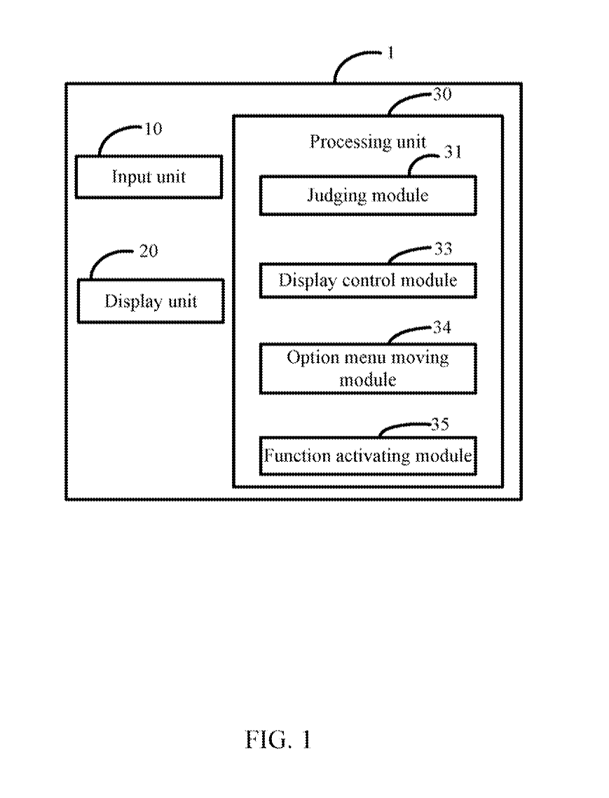

Referring to FIGS. 1-3, an electronic device 1 with a function of distinguishing the working state of option menus is provided. The electronic device 1 includes an input unit 10, a display unit 20, and a processing unit 30. The input unit 10 is configured for receiving the operations of a user.

The processing unit 30 includes a judging module 31, a display control module 33, an option menu moving module 34, and a function activating module 35.

The judging module 31 is configured for judging whether an operation from the input unit 10 is used to set functions of the option menus of the electronic device 1, such as, setting a function of the brightness of a display unit 20 of the electronic device, or setting a function of enabling/disabling BLUETOOTH.

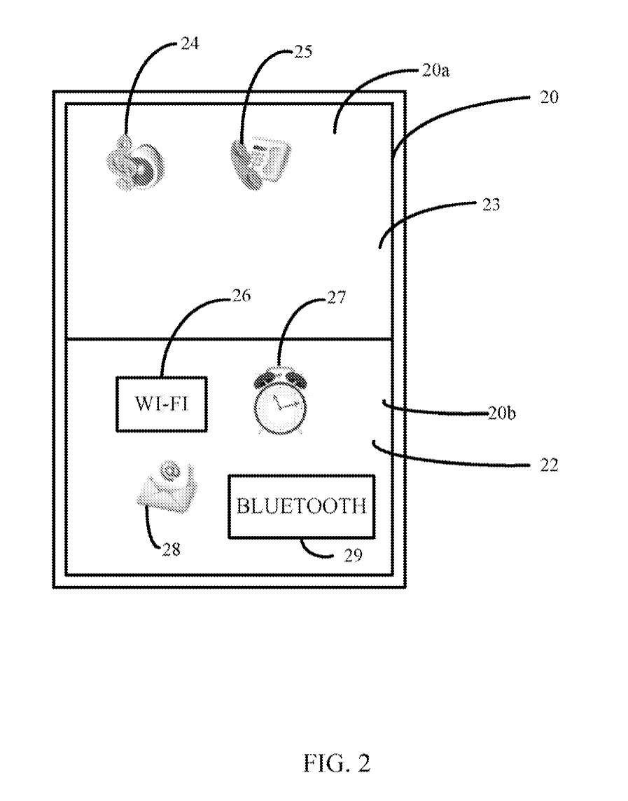

The display control module 33 is configured for displaying a function setting interface 23 when the judging module 31 determines that the operation from the input unit 10 is used to set functions of the option menus of the electronic device 1. The function setting interface 23 includes a first display area 20a and a second display area 20b. The display control module 33 is further configured for displaying the option menus which are activated on the first display area 20a, and displaying the option menus which are not activated on the second display area 20b. In one embodiment, an icon is used to represent an option menu. As shown in FIG. 2, a ring icon 24 is used to represent a ring option menu, a telephone icon 25 is used to represent a communications option menu. A WI-FI icon 26 is used to represent a WI-FI option menu, a clock icon 27 is used to represent to a clock option menu, a message icon 28 is used to represent to a message option menu, and a BLUETOOTH icon 29 is used to represent to a BLUETOOTH option menu. As described above, it is apparently distinguished that the functions of the ring icon 24 and the telephone icon 25 which are displayed in the first display area 20a have been activated, and the functions of the WI-FI icon 26, the clock icon 27, the message icon 28, and the BLUETOOOTH icon 29 which are displayed on the second display area 20b have not been activated.

The option menu moving module 34 is configured for moving an option menu being selected from the second display area 20b to the first display area 20a in response to a first dragging operation from the input unit 10.

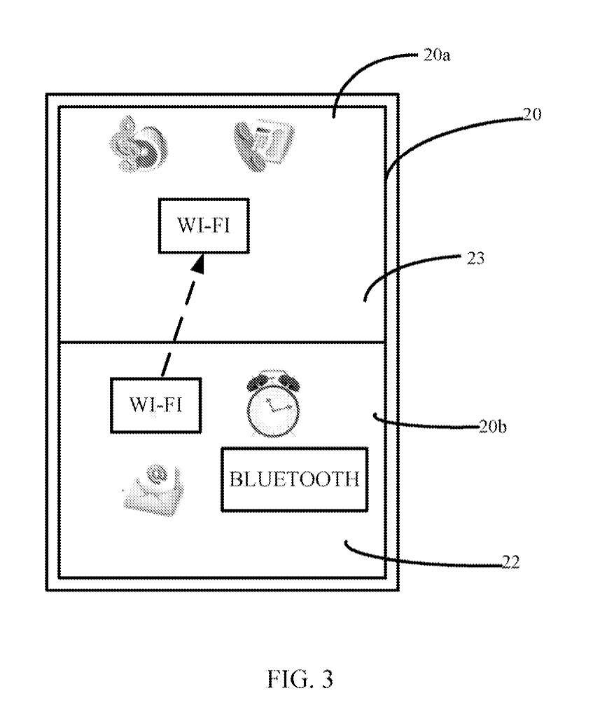

The function activating module 35 is configured for activating the functions of the option menu being moved into the first display area 20a from the second display area 20b. As shown in FIG. 3, a WI-FI option menu is being moved into the first display area 20a from the second display area 20b. The function activating module 35 activates the functions of the WI-FI option menu.

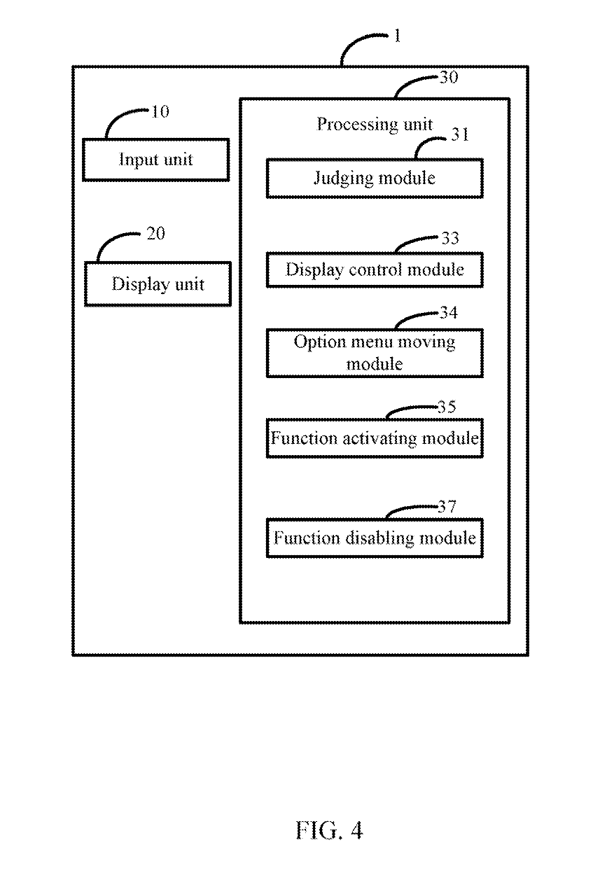

Referring to FIG. 4, a second embodiment of the electronic device 1, the option menu moving module 34 is further configured for moving the option menu being selected from the first display area 20a to the second display area 20b in response to a second dragging operation. The processing unit 30 further includes a function disabling module 37. The function disabling module 37 is configured for disabling the functions of the option menu being moved out of the first display area 20a.

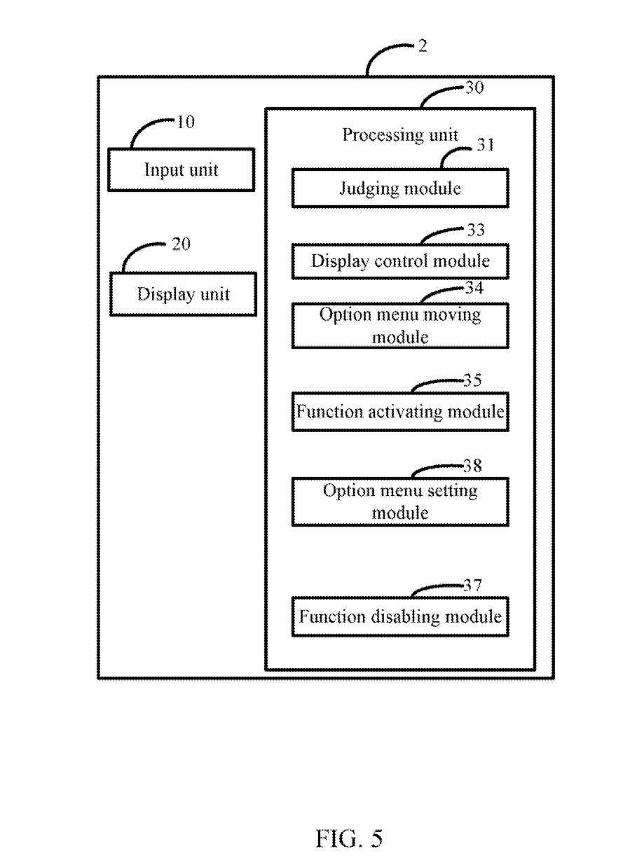

Referring to FIG. 5, a third embodiment of the electronic device 2, the processing unit 30 further includes an option menu setting module 38. The option menu setting module 38 is configured for setting the functions of the option menu being activated in response to the received operations of the user from the input unit 10, such as, when the BLUETOOTH option menu is activated, the option menu setting module 38 sets the functions of the BLUETOOTH.

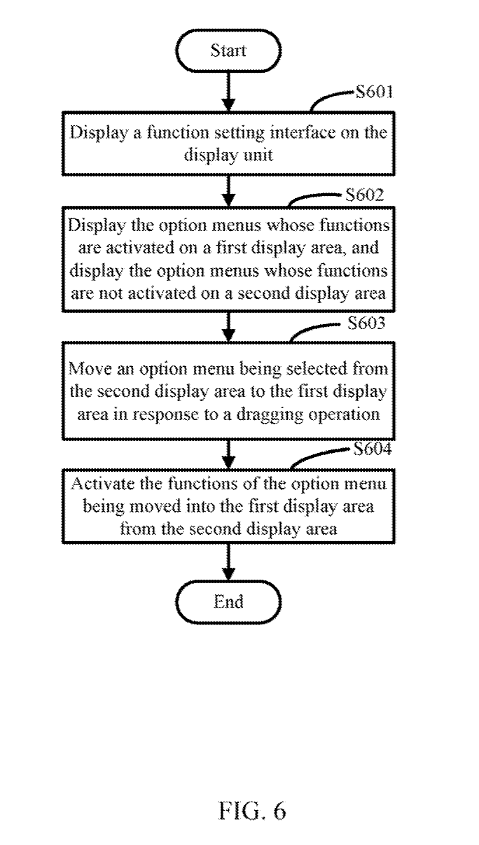

FIG. 6 is a flowchart of a method for distinguishing working state of option menus implemented by the electronic device of FIG. 1 in accordance with exemplary embodiment.

In step S601, the display control module 33 displays a function setting interface 23 including the first display area 20a and the second display area 20b on the display unit 20.

In step S602, the display control module 34 displays the option menus whose functions are activated on the first display area 20a, and displays the option menus whose functions are not activated on the second display area 20b.

In step S603, the option menu moving module 34 moves the option menu being selected from the second display area 20b to the first display area 20a in response to the dragging operation.

In step S604, the function activating module 35 activates the functions of the option menu being moved into the first display area 20a from the second display area 20b.

In other embodiments, the method further includes following steps: the option menu moving module 34 moves the option menu being selected from the first display area 20a to the second display area 20b in response to the dragging operation. In addition, the function disabling module 37 disables the functions of the option menu being moved out of the first display area 20a.

In other embodiments, the method further includes following steps: the option menu setting module 38 sets the functions of the option menu being activated in response to the operation of the user from the input unit 10.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device with a function of distinguishing working state of option menus, comprising:
an input unit for receiving user's operation;
a display unit; and
a processing unit comprising:
a display control module for displaying a function setting interface on the display unit, wherein the function setting interface comprises a first display area for displaying the option menus whose functions are activated and a second display area for displaying the option menus whose functions are not activated.

2. The electronic device as described in claim 1, wherein the processing unit further comprises a judging module for judging whether the received user's operation from the input unit is used to set functions of the option menus of the electronic device, the display control module displays the function setting interface when the received user's operation is used to set the functions of the option menus of the electronic device.

3. The electronic device as described in claim 1, wherein the processing unit further comprises an option menu moving module and a function activating module, the option menu moving module is configured for moving an option menu being selected from the second display area to the first display area in response to a first dragging operation from the input unit; and the function activating module is configured for activating the functions of the option menu being moved into the first display area from the second display area.

4. The electronic device as described in claim 3, wherein the option menu moving module is further configured for moving a selected option menu out of the first display area into the second display area in response to a second dragging operation, the processing unit further comprises a function disabling module for disabling the functions of the option menu being moved out of the first display area.

5. The electronic device as described in claim 1, wherein the processing unit further comprises an option menu setting module for setting the functions of the option menu being activated in response to the user's operation.

6. A method with a function of distinguishing working state of option menus implemented by en electronic device, the electronic device comprising an input unit for receiving user's operation and a display unit, the method comprising:
displaying a function setting interface on the display unit, wherein the function setting interface comprises a first display area for displaying the option menus whose functions are activated and a second display area for displaying the option menus whose functions are not activated.

7. The method as described in claim 6, further comprising:
judging whether the received user's operation from the input unit is used to set functions of the option menus of the electronic device; and
displaying the function setting interface on the display unit when the received user's operation is used to set functions of the option menus.

8. The method as described in claim 6, further comprising:
moving an option menu being selected from the second display area to the first display area in response to a first dragging operation from the input unit; and
activating the functions of the option menu being moved into the first display area from the second display area.

9. The method as described in claim 8, further comprising:
moving a selected option menu out of the first display area into the second display area in response to a second dragging operation; and
disabling the functions of the option menu being moved out of the first display area

10. The method as described in claim 6, further comprising:
setting the functions of the option menu being activated in response to the user's operation.
